(19) United States
(12) Patent Application Publication
(10) Pub. No.: US 2018/0295436 A1
(43) Pub. Date: Oct. 11, 2018

(54) BEVERAGE CONTAINER WIRELESS MICROPHONE

(71) Applicant: Sandra P. Fontana, Vero Beach, FL (US)

(72) Inventor: SANDRA P. FONTANA, Vero Beach, FL (US)

(21) Appl. No.: 14/939,566

(22) Filed: Nov. 12, 2015

(51) Int. Cl. H04R 1/08; H04R 1/04

(52) U.S. Cl. CPC H04R 1/086; H04R 2499/11; H04R 2420/07; H04R 1/04

(57) ABSTRACT

A portable electronic apparatus designed to replicate a commercial beverage container, wherein a wireless microphone and a wireless transmitter are contained and concealed. Audio signals generated by the said wireless microphone and the said wireless transmitter are directed as sound waves to one or more onsite processors configured to convert the audio signals to audible sound, and ultimately delivered to an audience. Intended for use in the public arena, the functional handheld wireless microphone serves as a marketing device for a commercial beverage company, creating the illusion that the user is holding a real beverage product when speaking or singing; that the user is sharing a real beverage when passing said device to another person; or that user is drinking a real beverage when singing or when tipping the device near his/her mouth. The device is also intended for intelligence gathering, surveillance, and espionage work by law enforcement professionals.

### BACKGROUND OF THE INVENTION

### Field of the Invention

This invention relates to the field of commercial product placement and branding. More particularly, advertising of a beverage product in a public setting, by virtue of a faux beverage container which houses a wireless microphone and wireless transmitter. Particularly, a wireless microphone and wireless transmitter are concealed inside a faux beverage container that is branded to facilitate the promotion of said beverage product during a function, performance or presentation.

Another field of the invention is in the area of surveillance and intelligence gathering by law enforcement professionals.

### DESCRIPTION OF RELATED ART

Wireless microphones convert audio signals into radio signals, which are sent by a transmitter through the air to a receiver. The receiver converts the radio signals back into audio signals, which are then sent through a sound system and directed to an audience.

Wireless microphones have been in use for many years. The present invention recognizes widespread use of wireless microphone technology. A wireless microphone eliminates the tangle of cables and wires on the performance platform or stage floor. Further, the wireless microphone allows for greater mobility of the speaker or performer. Typical adaptations include the handheld microphone, the lavaliere microphone, the headphone, and the body-mount microphone.

Likewise, beverage containers have become a standard delivery mechanism for the containment and transport of beverages. Multiple configurations constructed of numerous materials exist worldwide. Unique design, artwork, and commercial branding appear on most beverage containers, serving the purpose of promoting the contained beverage product.

### SUMMARY OF THE INVENTION

While wireless microphones and commercial beverage containers serve a purpose, the present invention substantially departs from the conventional interpretation of both devices by virtue of the novel configuration, being that a wireless microphone and a wireless transmitter are housed and concealed in a faux beverage container that gives the appearance of being an actual beverage container. In so doing, the present invention provides an apparatus that can be used for product placement, advertising, and marketing by giving the illusion that the performer or speaker is holding a real commercial beverage product.

Both the wireless microphone and the wireless transmitter are housed in the faux beverage container. A removable lid provides access to the microphone and transmitter, with the head of the wireless microphone being positioned within the lid, adjacent to the opening where a user's mouth would normally drink from the container. A wireless transmitter is disposed substantially toward the bottom of the faux beverage container. An antenna, being a component of the transmitter, sends audio signals from the transmitter through the air to an onsite receiver, which converts the radio signals back into audio signals, and broadcasts the sound to an audience.

The advantages of the present invention include that it is novel, portable, lightweight, and easy to transport. The present invention consists of a container that is easy to hold while performing, and allows a wide range of mobility. Without limitation, a facsimile of a company's beverage bottle, can, cup, or other commercial container would appear realistic during a performance or presentation in which the performer or speaker is holding the container. An important aspect of the invention relates to commercial marketing tied to the particular beverage container, configured so as to resemble a real commercial beverage product.

The present invention is a handheld electronic device that serves as a wireless microphone while appearing to be a commercial beverage.

When used by a law enforcement professional, the present invention disguises the fact that a wireless microphone is concealed within the faux beverage container, thereby enabling the device to be used as a surveillance tool.

The present invention is not suitable for the containment of a beverage.

The present invention introduces a unique adaptation of the wireless microphone, as a handheld unit that serves as a branded device that can be used to promote a beverage product.

The present invention introduces a unique adaptation of use for a beverage container, as a handheld unit that serves as a wireless microphone.

While the present invention incorporates the use of a faux beverage container, a removable lid, a wireless microphone, a wireless transmitter, and by extension, the use of a receiver, the essence of the invention is the marrying of a faux beverage container, a wireless microphone, and a wireless transmitter as one handheld unit, which by extension also utilizes a receiver.

When a performer or speaker holds the present invention in an upright position, he/she appears to be holding a commercial beverage product. When a performer or speaker moves the present invention toward a second performer or speaker, it appears he/she is sharing a commercial beverage with the second performer or speaker. When a performer or speaker tips the present invention at an angle toward his/her mouth, he/she appears to be drinking a beverage.

The present invention comprises a wireless microphone and a wireless transmitter concealed in a branded faux beverage container. The apparatus becomes a handheld wireless microphone used to promote a commercial beverage product in the public arena.

The present invention is a wireless microphone device that appears to be a branded beverage container. An intended use is in the entertainment industry, in which the audience members believe that the performer or speaker is holding a real commercial beverage product. This use serves to promote the branded beverage product.

An object of the present invention is to provide commercial branding for the particular beverage product featured on the device.

Items referenced as a “commercial beverage product” include, but are not limited to soda and soft drink products, tea and tea products, coffee and coffee products, sports drink products, energy drink products, beer and wine and other alcohol products, milk and milk drinks, water and water drinks, protein drinks, chopped-ice drinks, and other beverage products.

An object of the present invention is to provide commercial branding and/or product placement and/or promotion on television, in movies, and other broadcasts, of commercial beverage products.

Another object, without limitation, is to provide commercial branding and/or product placement and/or promotion of commercial beverage products via use of the present invention at events such as concerts; fairs and carnivals; festivals; parades; auto races; sporting events; athletic competitions; promotional events; observances; memorials; commemorations; remembrances; salutes; festivities; motivational events; charity functions; street performances; public events; and celebrations for New Year's, Fourth of July, Thanksgiving, Christmas, and other holiday and non-holiday events and celebrations; and at functions such as home shows, car shows, gun shows; and in such locations as night clubs, restaurants, theatres, schools, and auditoriums; and wherever a microphone would be suitable or necessary.

A further object is to attract attention to a presenter, performer or motivational speaker while he/she uses the present invention.

Another intended use is in law enforcement surveillance work, whereby the present invention causes the subject being interviewed by police to dismiss or disregard the faux beverage container, assuming it is a real beverage, and to therefore reveal information not otherwise obtainable.

Another intended use is in law enforcement undercover work, whereby police personnel hold the faux beverage container and speak surreptitiously into the device so as to appear nonchalant or “normal” allowing him/her to report covert information back to other law enforcement personnel.

Another intended use is as a bugging device. The faux beverage container, with a concealed microphone, could be set on a table or placed in a nearby trash container, appearing as a regular beverage container, although its usefulness would be in play, continuing to “listen.”

These and other objectives of the present invention will no doubt become obvious to those of ordinary skill in the art after reading the following detailed description of the preferred embodiments that are illustrated in the various figures and drawings.

The description herein utilizes a bottle, a can, or a cup as preferred embodiments of the invention, although these elements should not be construed as limiting the scope of the present invention, as other commercial beverage containers may be utilized.

Embodiments of the said faux beverage container may include a variety of shapes, sizes, and markings, and may be configured to resemble any real commercial beverage bottle, can, cup, or other handheld beverage container. The apparatus can be constructed of plastic, glass, cardboard, metal, or other lightweight materials.

Embodiments herein are illustrative only of the principles and physical appearance of the invention. Further, numerous modifications and changes will readily occur to those skilled in the art, such as beverage containers utilizing a straw, beverage containers with or without handle(s), beverage containers with different shapes, beverage containers of different sizes, beverage containers of different colors or markings. It is to be understood that such modifications not limit the invention to the specific constructions and arrangements shown and described, and accordingly, all suitable modifications and equivalents that may be resorted to, fall within the scope of the invention.

In broad embodiment, the present invention is a device that serves to promote a commercial beverage in the public arena, or which can be used as a surveillance tool by law enforcement personnel or undercover operatives.

### BRIEF DESCRIPTION OF THE DRAWINGS

FIG. 1 is a front view of a faux beverage container of the type configured for use in this invention as a handheld wireless microphone; with the example embodiment of a beverage bottle;

FIG. 2 constitutes a perspective view of a faux beverage container of the type configured for use in this invention as a handheld wireless microphone; with the example embodiment of a beverage bottle;

FIG. 3 is a fragmentary vertical sectional view of the invention; with the example embodiment of a beverage bottle;

FIG. 4 is a front view of a faux beverage container of the type configured for use in this invention as a handheld wireless microphone; with the example embodiment of a beverage can;

FIG. 5 constitutes a perspective view of a faux beverage container of the type configured for use in this invention as a handheld wireless microphone; with the example embodiment of a beverage can;

FIG. 6 is a fragmentary vertical sectional view of the invention; with the example embodiment of a beverage can;

FIG. 7 is a front view of a faux beverage container of the type configured for use in this invention as a handheld wireless microphone; with the example embodiment of a beverage cup;

FIG. 8 constitutes a perspective view of a faux beverage container of the type configured for use in this invention as a handheld wireless microphone; with the example embodiment of a beverage cup;

FIG. 9 is a fragmentary vertical sectional view of the invention; with the example embodiment of a beverage cup;

FIG. 10 illustrates a faux beverage container of the type configured for use in this invention as a handheld wireless microphone, in accordance with an example embodiment of a beverage can; being employed by a person who is a host, speaker, presenter, or law enforcement professional.

FIG. 11 illustrates a faux beverage container of the type configured for use in this invention as a handheld wireless microphone, in accordance with an example embodiment of a beverage bottle; being employed by a person who is a singer or performer;

### REFERENCE NUMERALS IN THE DRAWINGS

10 Beverage bottle top section
12 Beverage bottle bottom section
14 Product label with logo
16 Sound port at mouth opening of container
18 Bottle cap
20 Microphone head
22 Connector cord
24 Microphone connector
26 Wireless transmitter
28 Socket port for microphone
30 On/Off switch
32 Pilot light
34 Microphone head bracket
36 Transmitter bracket
38 Top assembly band
40 Assembly hook
42 Assembly hook port
44 Sound absorption pad
46 Bottom assembly band
48 Beverage can top section
50 Beverage can bottom section
52 Gasket
54 Beverage cup top section
56 Beverage cup bottom section
58 Host or speaker or performer
60 Beverage can wireless microphone
62 Singer or performer
64 Beverage bottle wireless microphone

### BRIEF DESCRIPTION OF THE SEVERAL VIEWS OF THE INVENTION

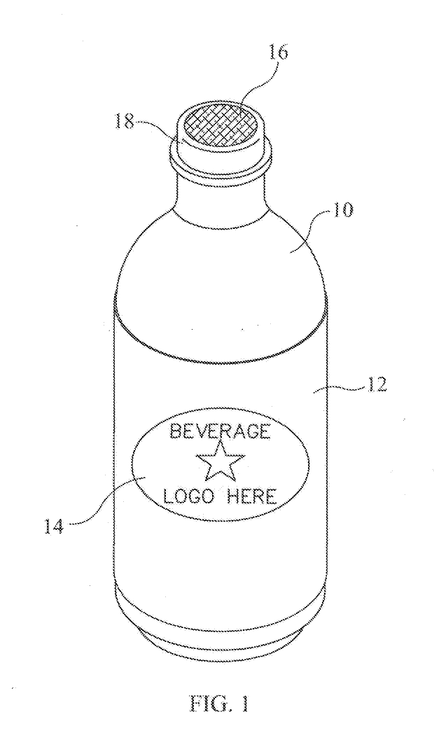

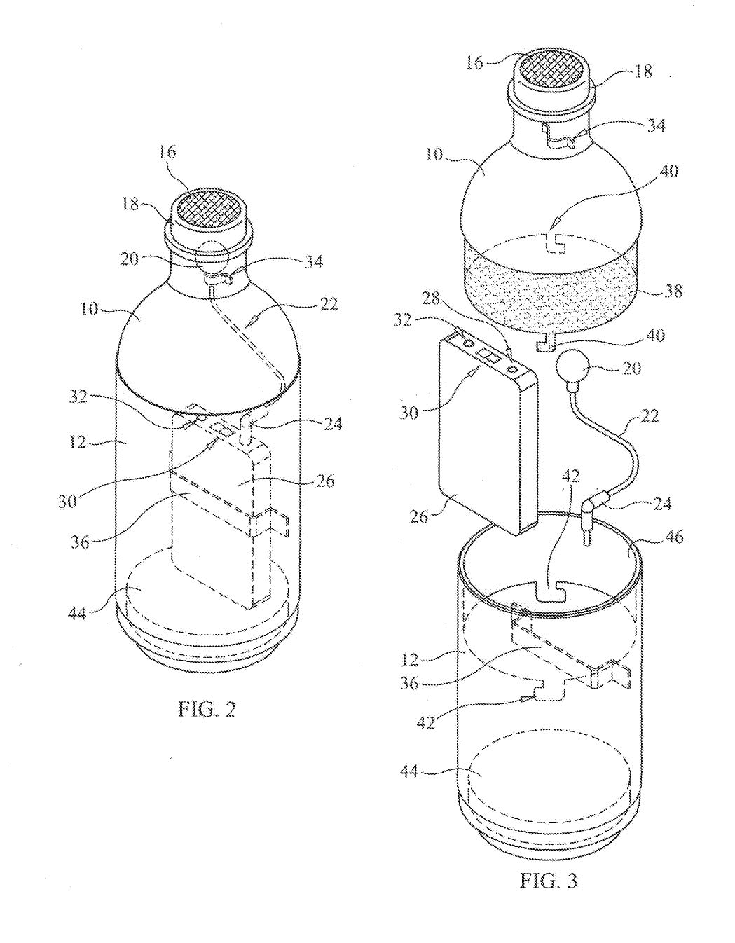

FIGS. 1, 2, and 3 show perspective views of the beverage “bottle” interpretation of the present invention, in which the wireless microphone and transmitter are contained and concealed. The dimensions and appearance are consistent with an actual beverage bottle with contents. The invention ideally includes installation features allowing the microphone and transmitter to be readily installed. FIG. 3 shows an example of such installation features, although the reader should bear in mind that many other possibilities exist.

The construction materials for the faux “beverage bottle” could be glass, various plastics, lightweight metals, metalized plastic, cardboard or other composites, and so on, giving the illusion of being an actual beverage bottle. Specifications for the transmitter and wireless microphone contained within the faux beverage bottle will vary according to the venue and the type of sound system used by the facilitator. The transmitter and wireless microphone components may be held against the inside wall of the container with brackets, which may be fabricated of the same material as the container, or of various other securing methods, such as hook-and-loop tape, elastic-like fabric, metal with magnets, or the like, depending on the material used to fabricate the faux beverage bottle. The faux beverage bottle opens with a screw twist at the middle, allowing the user to access the contents and the on/off switch of the transmitter. The opening/closing method is hidden by the bottle's label.

A shallow layer of foam padding may be applied to the interior bottom surface of the beverage container, as a sound absorption enhancement.

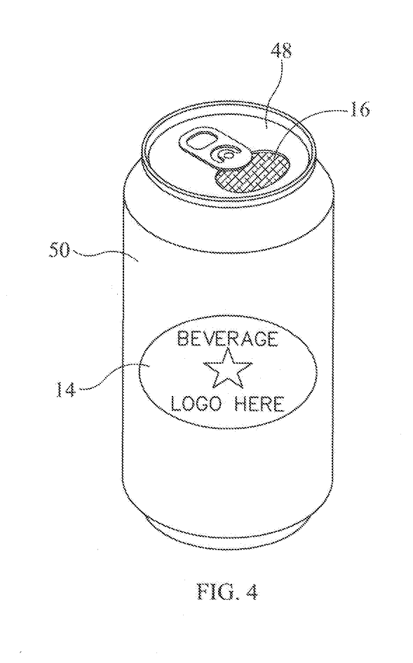

FIGS. 4, 5, and 6 show perspective views of the beverage “can” interpretation of the present invention, in which the wireless microphone and transmitter are contained and concealed. The dimensions and appearance are consistent with an actual beverage can. The invention ideally includes installation features allowing the microphone and transmitter to be readily installed. FIG. 6 shows one example of such installation features, although the reader should bear in mind that many other possibilities exist.

The construction materials for the faux “beverage can” could be glass, various plastics, lightweight metals, metalized plastic, cardboard or other composites, and so on, giving the illusion of being an actual beverage can. Specifications for the transmitter and wireless microphone contained within the faux beverage can will vary according to the venue and the type of sound system used by the facilitator. The transmitter and wireless microphone components may be held against the inside wall of the container with brackets, which may be fabricated of the same material as the container, or of various other securing methods, such as hook-and-loop tape, elastic-like fabric, metal with magnets, or the like, depending on the material used to fabricate the faux beverage can. The two primary sections of the faux beverage can open/close by virtue of a flexible gasket made of rubber or similar material, which holds the two pieces together, allowing user to access the contents and the on/off switch of the transmitter. As an alternative, the lid of the beverage can could open/close with a screw twist mechanism.

A shallow layer of foam padding is applied to the interior bottom surface of the beverage container, as a sound absorption enhancement.

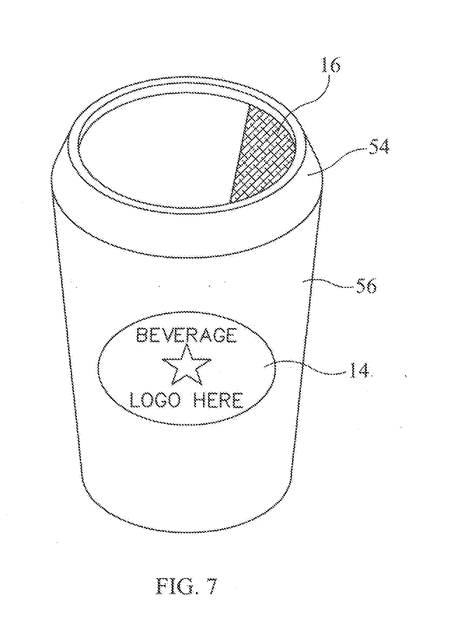

FIGS. 7, 8, and 9 show perspective views of the beverage “cup” interpretation of the present invention, in which the wireless microphone and transmitter are contained and concealed. The dimensions are consistent with an actual beverage cup. The invention ideally includes installation features allowing the microphone and transmitter to be readily installed. FIG. 9 shows one example of such installation features, although the reader should bear in mind that many other possibilities exist.

This interpretation is consistent with an actual beverage cup, opaque in nature, without a straw, without handles. Another interpretation of the faux beverage cup could have a straw and/or handles; and could appear to be transparent.

The construction materials for the faux “beverage cup” could be glass, various plastics, lightweight metals, metalized plastic, cardboard or other composites, and so on, giving the illusion of being an actual beverage cup. Specifications for the transmitter and wireless microphone contained within the faux beverage cup will vary according to the venue and the type of sound system used by the facilitator. The transmitter and wireless microphone components may be held against the inside wall of the container with brackets, which may be fabricated of the same material as the container, or of various other securing methods, such as hook-and-loop tape, elastic-like fabric, metal with magnets, or the like, depending on the material used to fabricate the faux beverage cup. The two primary sections of the faux beverage cup open/close by virtue of a flexible gasket made of rubber or similar material that holds the two pieces together, allowing user to access the contents and the on/off switch of the transmitter. As an alternative, the lid of the beverage can could open/close with a screw twist mechanism.

A shallow layer of foam padding is applied to the interior bottom surface of the beverage container, as a sound absorption enhancement.

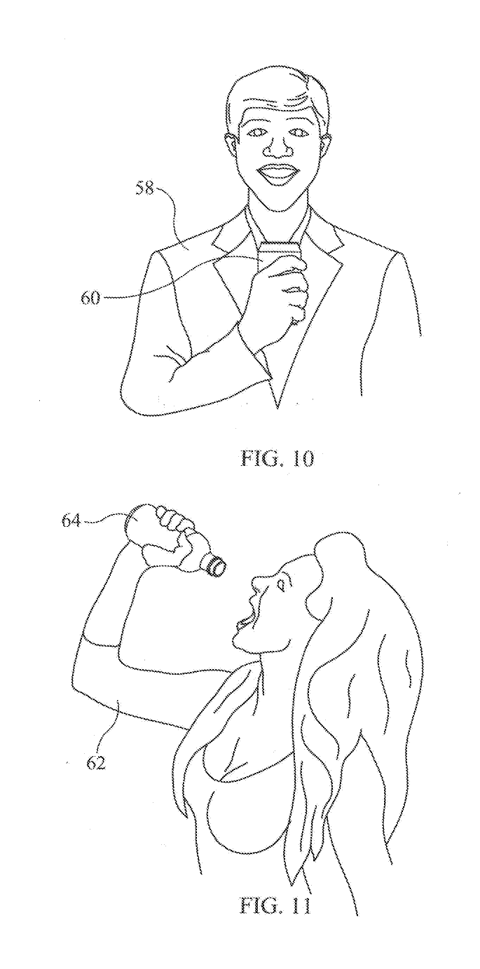

FIG. 10 is a perspective view, showing a host, speaker, presenter, or law enforcement professional as the user of the beverage “can” interpretation of the present invention.

FIG. 11 is a perspective view, showing a singer or performer as the user of the beverage “bottle” interpretation of the present invention. The device attracts promotional attention during a performance. Holding the device at a tipped angle causes the illusion that the singer/performer is drinking a beverage from the container.

### DETAILED DESCRIPTION OF THE INVENTION

FIGS. 1, 4, and 7 illustrate embodiments of a beverage container wireless microphone according to the present invention.

In the illustrated embodiment of a beverage bottle, the container in FIG. 1 may be formed in imitation of a conventional commercial beverage product, and may be made from glass, various plastics, lightweight metals, metalized plastic, cardboard or other composites, and so on. In a preferred embodiment of the invention, FIG. 1 depicts the invention as a beverage bottle, in which a wireless microphone and wireless transmitter are contained and concealed. Accordingly, a sound port at the mouth opening of the container (16) is built into the portion that appears to be the bottle cap (18), enabling user's voice to make contact with microphone head (20) [not visible in FIG. 1]. The handheld device primarily consists of two segments, a beverage bottle top section (10) and a beverage bottle bottom section (12). The product label with logo (14) simulates that of a conventional commercial beverage product.

As illustrated in FIG. 2, the beverage container wireless microphone, configured to represent a beverage bottle, depicts the concealed components related to the wireless microphone and wireless transmitter. The user's voice may make contact with the microphone head (20) through the sound port at mouth opening of container (16), located within what appears to be a bottle cap (18). Microphone head (20) may be secured in place in the beverage bottle top section (10) with the use of a microphone head bracket (34), which may be fabricated of the same material as the container, of hook and loop tape, metal with magnets, elastic-like fabric, or a fastener, although the invention does not limit the method to these particular options. The type material of which the container is fabricated will likely dictate the method used to secure the transmitter and microphone head. Microphone head is connected by virtue of a cord (22) and a microphone connector (24) into wireless transmitter (26), which is installed in the beverage bottle bottom section (12). Wireless transmitter is configured with a socket port for microphone (28) [not visible in FIG. 2], an on/off switch (30), and a pilot light (32). Wireless transmitter (26) may be secured in place with a transmitter bracket (36), which may be fabricated of the same material as the container, of hook and loop tape, metal with magnets, elastic-like fabric, or a fastener, although the invention does not limit the method to these particular options. The type material of which the container is fabricated will likely dictate the method used to secure the transmitter and microphone head. A sound absorption pad (44) may be applied on the interior bottom of the container. Said sound absorption pad may be constructed of foam rubber or the like.

As illustrated in FIG. 3, the beverage container wireless microphone, configured to represent a beverage bottle, depicts the assembly of the device's components. To ready the device for use, the microphone head (20), accordingly connected to the connector cord (22), may be secured in place with a microphone head bracket (34), said bracket mounted or formed against the interior wall of the beverage bottle top section (10). A microphone connector (24) plugs into the wireless transmitter (26) at the socket port for microphone (28). User would activate the battery-operated current of the wireless transmitter (26) with the on/off switch (30). A pilot light (32) would indicate whether the wireless transmitter is operational. The wireless transmitter (26) may be secured in place with a transmitter bracket (36) mounted or formed against the interior wall of the beverage bottle bottom section (12). A sound absorption pad (44) may be applied on the interior bottom of the container. To bring the top and bottom pieces together, the beverage bottle top section (10) slides down into the beverage bottle bottom section (12), lining up the assembly hooks (40) on the top assembly band (38) with the assembly hook ports (42) on the bottom assembly band (46). The top assembly band (38) becomes concealed within the bottom assembly band (46) and is no longer visible once the top and bottom sections are connected. A clockwise twist motion will hold the unit closed. As an alternative, a screw-like method of closure could be implemented.

In the illustrated embodiment of a beverage can, the container in FIG. 4 may be formed in imitation of a conventional commercial beverage product, and may be may be made from glass, various plastics, lightweight metals, metalized plastic, cardboard or other composites, and so on. In a preferred embodiment of the invention, FIG. 4 depicts the invention as a beverage can, in which a wireless microphone and wireless transmitter are contained and concealed. Accordingly, a sound port at the mouth opening of the container (16) is built into the beverage can top section (48), enabling user's voice to make contact with microphone head (20) [not visible in FIG. 4]. The handheld device primarily consists of two segments, a beverage can top section (48) and a beverage can bottom section (50). The product label with logo (14) simulates that of a conventional commercial beverage product.

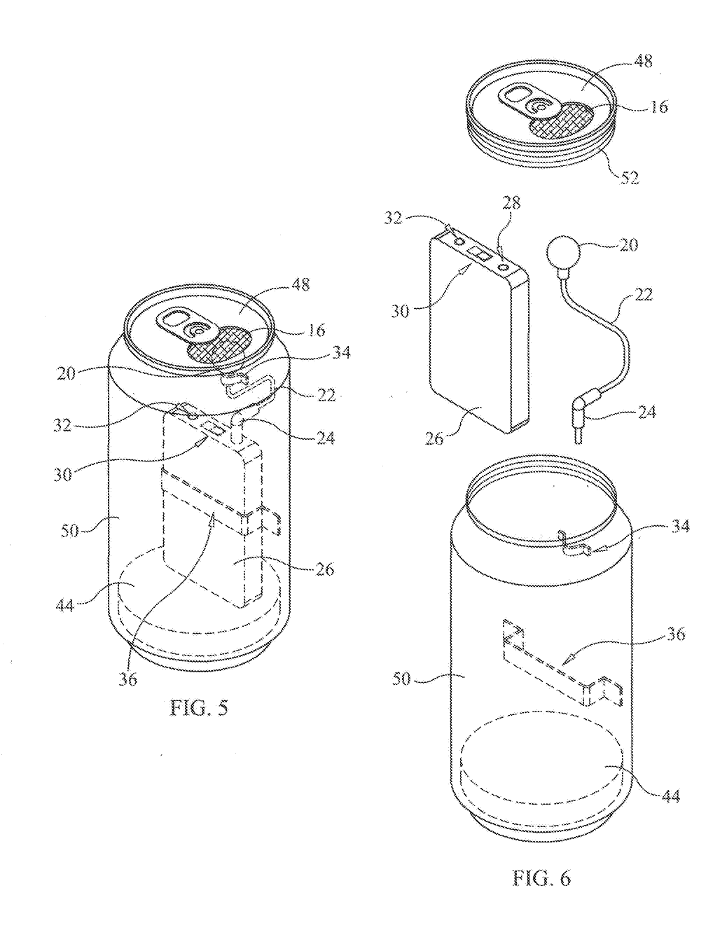

As illustrated in FIG. 5, the beverage container wireless microphone, configured to represent a beverage can, depicts the concealed components related to the wireless microphone and wireless transmitter. The user's voice may make contact with the microphone head (20) through the sound port at mouth opening of container (16). Microphone head (20) may be secured in place in the beverage can top section (48) with the use of a microphone head bracket (34), which may be fabricated of the same material as the container, of hook and loop tape, metal with magnets, elastic-like fabric, or a fastener, although the invention does not limit the method to these particular options. The type material of which the container is fabricated will likely dictate the method used to secure the transmitter and microphone head. Microphone head is connected by virtue of a cord (22) and a microphone connector (24) into wireless transmitter (26), which is installed in the beverage can bottom section (50). Wireless transmitter is configured with a socket port for microphone (28) [not visible in FIG. 5], an on/off switch (30), and a pilot light (32). Wireless transmitter (26) may be secured in place with a transmitter bracket (36), which may be fabricated of the same material as the container, of hook and loop tape, metal with magnets, elastic-like fabric, or a fastener, although the invention does not limit the method to these particular options. The type material of which the container is fabricated will likely dictate the method used to secure the transmitter and microphone head. A sound absorption pad (44) may be applied on the interior bottom of the container. Said sound absorption pad may be constructed of foam rubber or the like.

As illustrated in FIG. 6, the beverage container wireless microphone, configured to represent a beverage can, depicts the assembly of the device's components. To ready the device for use, the microphone head (20), accordingly connected to the connector cord (22), may be secured in place with a microphone head bracket (34), said bracket mounted or formed against the interior wall of the beverage can top section (48). A microphone connector (24) plugs into the wireless transmitter (26) at the socket port for microphone (28). User would activate the battery-operated current of the wireless transmitter (26) with the on/off switch (30). A pilot light (32) would indicate whether the wireless transmitter is operational. The wireless transmitter (26) may be secured in place with a transmitter bracket (36) mounted or formed against the interior wall of the beverage can bottom section (50). A sound absorption pad (44) may be applied on the interior bottom of the container. To bring the top and bottom pieces together, the beverage can top section (48) slides into the beverage can bottom section (50). The flexible gasket (52) along the bottom edge of the beverage can top section (48) forms a friction lock with the beverage can bottom section (50) to hold the unit closed. As an alternative, a screw-like method of closure could be implemented.

In the illustrated embodiment of a beverage cup, the container in FIG. 7 may be formed in imitation of a conventional commercial beverage product, and may be may be made from glass, various plastics, lightweight metals, metalized plastic, cardboard or other composites, and so on. In a preferred embodiment of the invention, FIG. 7 depicts the invention as a beverage cup, in which a wireless microphone and wireless transmitter are contained and concealed. Accordingly, a sound port at the mouth opening of the container (16) is built into the beverage cup top section (54), enabling user's voice to make contact with microphone head (20) [not visible in FIG. 7]. The handheld device primarily consists of two segments, a beverage cup top section (54) and a beverage cup bottom section (56). The product label with logo (14) simulates that of a conventional commercial beverage product.

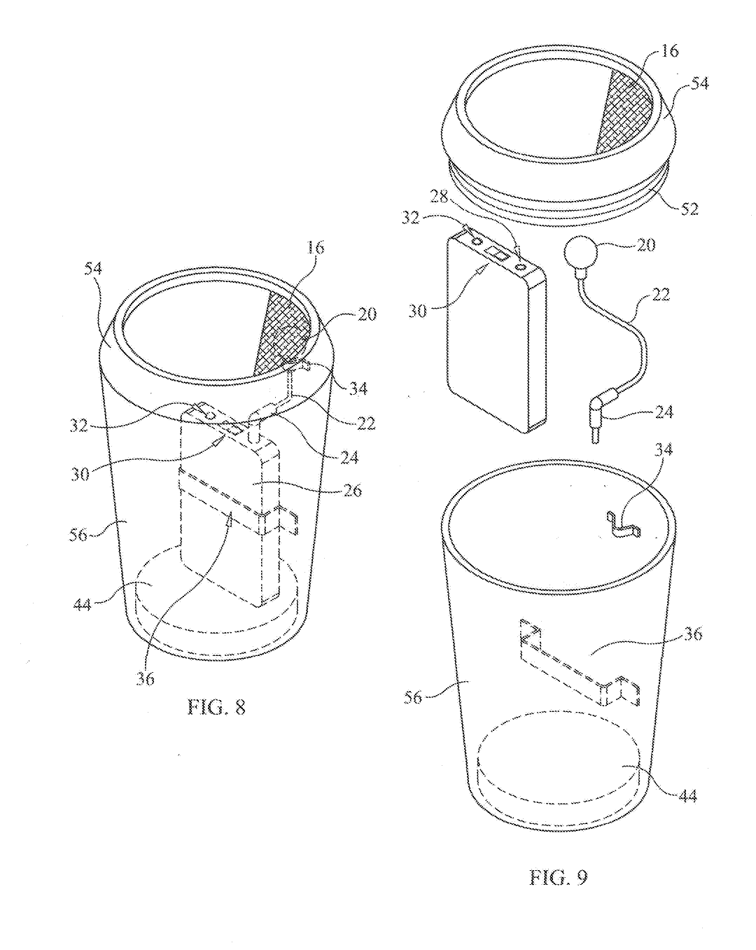

As illustrated in FIG. 8, the beverage container wireless microphone, configured to represent a beverage cup, depicts the concealed components related to the wireless microphone and wireless transmitter. The user's voice may make contact with the microphone head (20) through the sound port at mouth opening of container (16). Microphone head (20) may be secured in place in the beverage cup top section (54) with the use of a microphone head bracket (34), which may be fabricated of the same material as the container, of hook and loop tape, metal with magnets, elastic-like fabric, or a fastener, although the invention does not limit the method to these particular options. The type material of which the container is fabricated will likely dictate the method used to secure the transmitter and microphone head. Microphone head is connected by virtue of a cord (22) and a microphone connector (24) into wireless transmitter (26), which is installed in the beverage cup bottom section (56). Wireless transmitter is configured with a socket port for microphone (28) [not visible in FIG. 8], an on/off switch (30), and a pilot light (32). Wireless transmitter (26) may be secured in place with a transmitter bracket (36), which may be fabricated of the same material as the container, of hook and loop tape, metal with magnets, elastic-like fabric, or a fastener, although the invention does not limit the method to these particular options. The type material of which the container is fabricated will likely dictate the method used to secure the transmitter and microphone head. A sound absorption pad (44) may be applied on the interior bottom of the container. Said sound absorption pad may be constructed of foam rubber or the like.

As illustrated in FIG. 9, the beverage container wireless microphone, configured to represent a beverage cup, depicts the assembly of the device's components. To ready the device for use, the microphone head (20), accordingly connected to the connector cord (22), may be secured in place with a microphone head bracket (34), said bracket mounted or formed against the interior wall of the beverage cup top section (54). A microphone connector (24) plugs into the wireless transmitter (26) at the socket port for microphone (28). User would activate the battery-operated current of the wireless transmitter (26) with the on/off switch (30). A pilot light (32) would indicate whether the wireless transmitter is operational. The wireless transmitter (26) may be secured in place with a transmitter bracket (36) mounted or formed against the interior wall of the beverage cup bottom section (56). A sound absorption pad (44) may be applied on the interior bottom of the container. To bring the top and bottom pieces together, the beverage cup top section (54) slides into the beverage cup bottom section (56). The flexible gasket (52) at the bottom edge of the beverage cup top section (54) forms a friction lock with the beverage cup bottom section (56) to hold the unit closed. As an alternative, a screw-like method of closure could be implemented.

### CONCLUSION

While certain exemplary embodiments have been described and shown in the accompanying drawings, it is to be understood that such embodiments are merely illustrative of and not restrictive of the broad invention, that many variations and modifications may be effected within the spirit and scope of the invention as described in the appended claims, and that this invention not be limited to the specific constructions and arrangements shown and described, since various modifications and alterations of the device may be made while retaining the essence of the invention, and other modifications may occur to those ordinarily skilled in the art.

The embodiments of the invention in which exclusive property or privilege are claimed are defined as follows:

1. A method of providing a marketing experience with a wireless communication device, comprising: a main housing appearing to be a commercial beverage container, the said main housing having a defined cavity; a removable lid; and at least one interactive sound-generating device which receives audio input from a user, optimally transmitting sound waves via ultrasound to one or more onsite processors configured to convert the audio signals to audible sound; and ultimately delivering same to an audience.

2. A method of providing surveillance operations with a wireless communication device, comprising: a main housing appearing to be a commercial beverage container; the said main housing having a defined cavity; a removable lid; and at least one interactive sound-generating device which receives audio input from a user, optimally transmitting sound waves via ultrasound to one or more processors configured to convert the audio signals to audible sound; and ultimately delivering same to a specified authority.

3. The method of claims 1 and 2, whereby the main housing of the wireless communication device can be constructed of plastic, glass, cardboard, metal, or other lightweight materials.

4. The method of claims 1 and 2, whereby the interactive sound-generating device consists of a wireless transmitter and a wireless microphone assembly.

5. The method of claims 1 and 2, wherein the said wireless microphone, being part of the said wireless transmitter and wireless microphone assembly, is contained and concealed within the said main housing and affixed adjacent to the mouth opening; and is operably coupled with the said wireless transmitter.

6. The method of claims 1 and 2, wherein the said wireless transmitter and said wireless microphone are coupled, have a power supply, and an on/off switch and other controls, wherein user can service and control the housed wireless transmitter and wireless microphone.

7. The method of claims 1 and 2, wherein the source of electrical power is a battery.

8. The method of claims 1 and 2, wherein the lid of the wireless communication device includes a screened opening by which the user's voice can be received by the microphone.

9. The method of claims 1 and 2, wherein the wireless communication device is characterized by replicating a commercial beverage product.

10. The method of claim 1, wherein the wireless communication device is characterized by its resemblance to a commercial beverage bottle, beverage can, beverage cup, or other commercial beverage container, so as to be used for marketing by virtue of appearing realistic during a performance or presentation in which the performer or speaker is holding the container; and to give the impression that the performer or speaker is consuming a commercial beverage.

11. The method of claim 2, wherein the wireless communication device is characterized by its resemblance to a commercial beverage bottle, beverage can, beverage cup, or other commercial beverage container, so as to be used for surveillance or intelligence work by law enforcement professionals by virtue of appearing realistic during undercover operations in which the police officer is holding the container and/or speaking into the container, while giving the impression that he/she is consuming a commercial beverage.

12. The method of claim 2, wherein the wireless communication device is characterized by its resemblance to a commercial beverage bottle, beverage can, beverage cup, or other commercial beverage container, so as to be used for surveillance or intelligence gathering work by law enforcement professionals by virtue of appearing realistic during undercover operations in which the police officer places the container in an environment in which information may be surreptitiously gathered, while giving the impression that the device is a commercial beverage.

13. The method of claims 1 and 2, wherein the wireless communication device described herein utilizes a beverage bottle, a beverage can, or a beverage cup as preferred embodiments of the invention, although these elements should not be construed as limiting the scope of the invention.

14. The method of claims 1 and 2, wherein the wireless communication device shall not be limited to interpretations described herein, as beverage containers utilizing a straw, beverage containers with or without handle(s), beverage containers with different shapes, beverage containers of different sizes, beverage containers of different colors or markings, beverage containers that are transparent or opaque, fall within the scope of the invention.

15. Without limitation, the present invention introduces a unique adaptation of the wireless microphone, as a handheld unit that serves as a branded device that can be used to promote a beverage product.

16. Without limitation, the present invention introduces a unique adaptation of use for a beverage container, as a handheld unit that serves as a wireless microphone.
